(19) United States
(12) Patent Application Publication
(10) Pub. No.: US 2025/0237263 A1
(43) Pub. Date: Jul. 24, 2025

(54) FLUID DYNAMIC PRESSURE BEARING OIL, SPINDLE MOTOR, AND DISK DRIVE DEVICE

(71) Applicant: MINEBEA MITSUMI Inc., Nagano (JP)

(72) Inventors: Motojiro TSUNA, Kitasaku-gun, Nagano (JP); Jun HATCHO, Kitasaku-gun, Nagano (JP); Takuya KITAJIMA, Kitasaku-gun, Nagano (JP)

(21) Appl. No.: 18/703,551

(22) PCT Filed: Oct. 25, 2022
(86) PCT No.: PCT/JP2022/039765

§ 371 Date: Apr. 22, 2024

(30) Foreign Application Priority Data
Oct. 25, 2021 (JP) 2021-174016

(51) Int. Cl. F16C 33/10; C10M 129/70; C10M 129/72; C10N 20/00; C10N 30/00; C10N 30/10; C10N 40/02; C10N 40/18; G11B 5/60

(52) U.S. Cl. CPC F16C 33/109; C10M 129/70; C10M 129/72; F16C 33/103; G11B 5/6005; C10M 2207/124; C10M 2207/128; C10M 2207/281; C10M 2207/282; C10M 2207/284; C10M 2207/285; C10M 2219/09; C10N 2020/085; C10N 2030/10; C10N 2030/40; C10N 2040/02; C10N 2040/18; F16C 2210/04; F16C 2380/26

(57) ABSTRACT

Object

To provide a fluid dynamic pressure bearing oil and a fluid dynamic pressure bearing filled with the fluid dynamic pressure bearing oil, and to provide a spindle motor and a disk drive device including the spindle motor in which the fluid dynamic pressure bearing oil and the bearing are used, thereby suppressing adhesion of a volatile component to a magnetic disk or the like even when the fluid dynamic pressure bearing oil is volatilized, so that occurrence of HDD read/write errors can be suppressed.

Solution

A fluid dynamic pressure bearing oil contains at least one compound selected from the group consisting of a monoester compound represented by the following Formula (1) and a diester compound represented by the following Formula (2): R₁—C(═O)O—R₂ (1) (where R₁ is an alkyl group having 10 or more carbon atoms in total, R₂ is an alkyl group having 9 or more carbon atoms in total, and R₃-E₁-R₄-E₂-R₅ (2) (where R₃ and R₅ are each independently an alkyl group having 8 or more carbon atoms in total, R₄ is an alkylene group having 4 or more carbon atoms in total, and E₁ and E₂ are each independently —C(═O)O— or —OC(═O)—.

### TECHNICAL FIELD

The present invention relates to a fluid dynamic pressure bearing oil, a fluid dynamic pressure bearing filled with the fluid dynamic pressure bearing oil, and a spindle motor.

### BACKGROUND ART

Various lubricants such as grease and oil are used for pivot assemblies used in fulcrum portions of actuators of hard disk drives (HDDs) and bearings incorporated in spindle motors for smooth operation of these components and smooth driving of these devices.

For example, a rolling bearing incorporated in a hard disk drive actuator has been proposed in which the rolling bearing is filled with a grease produced by blending, as a thickener, a diurea compound having at least one of an alicyclic hydrocarbon group or an aliphatic hydrocarbon group in its skeleton in a base oil containing an aromatic ester oil (Patent Document 1).

### CITATION LIST

### Patent Document

Patent Document 1: JP 2006-236410 A

### SUMMARY OF INVENTION

### Technical Problem

An example of causes of occurrence of read/write errors in HDDs is volatilization of a lubricant component, for example, a base oil, filled in the bearing incorporated in the actuator or spindle motor. When the volatilized base oil is cooled, condensed on the surface of a magnetic disk or a magnetic head, and adheres to the surface of the magnetic disk or the magnetic head as a liquid or a solid, the magnetic disk and the magnetic head are attracted to each other and normal reading and writing are not possible, resulting in a cause of read/write errors.

It is difficult to completely eliminate the volatilization of the lubricant component even if the volatilization amount is suppressed by selecting, for example, a low-volatile base oil against the volatilization of the lubricant component due to the temperature rise during the HDD driving.

An object of the present invention is to provide a fluid dynamic pressure bearing oil and a fluid dynamic pressure bearing filled with the fluid dynamic pressure bearing oil, and to provide a spindle motor and a disk drive device including the spindle motor in which the fluid dynamic pressure bearing oil and the bearing are used, thereby suppressing adhesion of a volatile component to a magnetic disk or the like even when the fluid dynamic pressure bearing oil is volatilized, so that occurrence of HDD read/write errors can be suppressed.

### Solution to Problem

In one aspect, the present invention relates to a fluid dynamic pressure bearing oil for
use in a disk drive device, the fluid dynamic pressure bearing oil including:

at least one compound selected from the group consisting of a monoester compound represented by the following Formula (1) and a diester compound represented by the following Formula (2):

R₁—C(═O)O—R₂ (1)
where
R₁ is a linear or branched alkyl group having 10 or more carbon atoms in total, and when R₁ is a branched alkyl group, a number of carbon atoms in a side chain is 10 or more;
R₂ is a linear or branched alkyl group having 9 or more carbon atoms in total, and when R₂ is a branched alkyl group, a number of carbon atoms in a side chain is 7 or more, R₃-E₁-R₄-E₂-R₅ (2)
where
R₃ and R₅ are each independently a linear or branched alkyl group having 8 or more carbon atoms in total, and when R₃ and R₅ are branched alkyl groups, a number of carbon atoms in the longest carbon chain counted from a carbon atom bonded to E₁ or E₂ is 9 or more,
R₄ is a linear or branched alkylene group having 4 or more carbon atoms in total, and
E₁ and E₂ each independently represent —C(═O)O— or —OC(═O)—.

The present invention also relates to a fluid dynamic pressure bearing filled with the fluid dynamic pressure bearing oil.

Furthermore, the present invention relates to a spindle motor including the fluid dynamic pressure bearing.

Moreover, the present invention relates to a disk drive device equipped with the spindle motor.

### BRIEF DESCRIPTION OF DRAWINGS

FIG. 1 is a conceptual diagram illustrating an example of a main component structure of a spindle motor of the present invention.

FIG. 2 is a schematic view illustrating an example of a structure of a drive device (disk drive device) of the present invention.

### DESCRIPTION OF EMBODIMENTS

As described above, regarding a lubricant for use in actuators or spindle motors of HDDs, an approach for suppressing the volatilization of the lubricant component (outgas generation and the like), which is considered as a cause of read/write errors in HDDs, has been proposed.

However, even though the volatilization of the lubricant component generally used is suppressed, the volatilization itself is not eliminated. In known disk drive devices, the fly height (the distance between the magnetic head and the disk) is sufficiently large. Therefore, if the volatile component can be reduced, it had been possible to avoid the read/write errors. However, in association with the increase in recording density, the fly height is reduced to about several nanometers. In this case, it is considered that a negative pressure state is generated in a gap between the magnetic head and the disk. As a result, a gas around the gap enters the gap between the magnetic head and the disk and is compressed therein. The compressed gas may be condensed, and a very small amount of volatile component may be liquefied. In recent years, with an increase in the recording capacity per HDD, the number of disks in the device has increased, and disk drive devices having 9 or more 3.5-inch-diameter disks have been put on the market. In such a device, a spatial volume within the device is further reduced. In such an environment having a small spatial volume and a fly height on the order of several nanometers, even a very small amount of contamination may lead to read/write errors.

A disk drive device including an internal space filled with a gas (for example, helium or the like) having a lower density than air has also started to spread. In such a disk drive device, the air pressure inside the device may be less than one atmosphere. This makes it more difficult to suppress volatilization of a lubricant component. In particular, in the case of an HDD employing a heat-assisted magnetic recording (HAMR) system which is a next-generation recording technology, the temperature of a head portion of an actuator can locally reach a temperature as high as 400° C. Thus, the internal temperature of the HDD rises, and even when low-volatile base oil is used, the volatilization amount of a lubricant component may not be reduced. While the volatilization of the lubricant component has become more problematic as described above, the present inventors have diligently pursued for a better solution for the conventional problem in order to provide a lubricant with low volatile components. The present inventors have studied the components of the lubricant based on a new idea to achieve a configuration with which the adhesion of the volatile component to the disk would be difficult even if the volatilization of the volatile component occurs (even if the adhesion occurs, the volatile component would not remain on the disk). The present inventors firstly found that a fluid dynamic pressure bearing oil that realizes the new idea can be obtained by using, as a component of a lubricant, an aliphatic monoester compound or diester compound with a certain alkyl chain length or longer.

Hereinafter, the fluid dynamic pressure bearing oil of the present invention will be described in detail.

### [Fluid Dynamic Pressure Bearing Oil]

A fluid dynamic pressure bearing oil used in a fluid dynamic pressure bearing and a spindle motor of the present invention described below contains at least one compound selected from the group consisting of an aliphatic monoester compound and diester compound having specific alkyl chain lengths.

### <Monoester Compound>

The monoester compound is represented by Formula (1).

R₁—C(═O)O—R₂ (1)
where

R₁ is a linear or branched alkyl group having 10 or more carbon atoms in total, and preferably 23 or less carbon atoms in total. When R₁ is a branched alkyl group, a number of carbon atoms in a side chain is 10 or more, and may be preferably 15 or less.

R₂ is a linear or branched alkyl group having 9 or more carbon atoms in total, and preferably 20 or less carbon atoms in total. When R₂ is a branched alkyl group, a number of carbon atoms in a side chain is 7 or more, and may be preferably 8 or less.

In the specification, the number of carbon atoms in the side chain is the number of carbon atoms in the side chain portion(s) of a branched alkyl group, and is not a number of carbon atoms counted from a carbon atom bonded to a carbonyl group (—C(═O)—) or an oxygen atom (—O—).

In a preferred embodiment, one of R₁ and R₂ may be a linear alkyl group, and the other one may be a branched alkyl group.

### <Diester Compound>

The diester compound is represented by Formula (2).

R₃-E₁-R₄-E₂-R₅ (2)
where

R₃ and R₅ each independently represent a linear or branched alkyl group having 8 or more carbon atoms in total, and preferably 10 or less carbon atoms in total. When R₃ and R₅ are branched alkyl groups, a number of carbon atoms in the longest carbon chain counted from the carbon atom bonded to E₁ or E₂ may be 9 or more, and preferably 9.

R₄ is a linear or branched alkylene group having 4 or more carbon atoms in total and preferably 6 or less carbon atoms in total.

Here, it is preferable that R₃ and R₅ be both linear alkyl groups and R₄ be a branched alkyl group, or that R₃ and R₅ be both branched alkyl groups and R₄ be a linear alkyl group.

E₁ and E₂ each independently represent —C(═O)O— or —OC(═O)—.

In a preferred embodiment, R₃ and R₅ may be an identical group.

Moreover, for E₁ and E₂, E₁ represents —C(═O)O— and E₂ represents —OC(═O)—, or E₁ represents —OC(═O)— and E₂ represents —C(═O)O—.

For example, in the compound, R₃ and R₅ represent an identical linear alkyl group, R₄ represents an identical branched alkyl group, E₁ represents —C(═O)O—, and E₂ represents-OC(═O)—.

Alternatively, R₃ and R₅ represent an identical branched alkyl group, R₄ represents an identical linear alkyl group, E₁ represents —OC(═O)—, and E₂ represents —C(═O)O—.

### <Additives>

The fluid dynamic pressure bearing oil of the present invention may contain, if necessary, an additive usually used in fluid dynamic pressure bearing oils within a range not impairing the effect of the present invention.

Examples of the additive include extreme pressure additives, mineral oils, combined base oils such as poly-α-olefins, antioxidants, metal cleaners, oiliness agents, anti-wear agents, metal deactivators, corrosion inhibitors, rust inhibitors, viscosity index improvers, pour point depressants, conductivity imparting agents, dispersants, anti-foaming agents, and hydrolysis inhibitors.

Well-known extreme pressure additives containing sulfur, chloride, phosphorus, or the like can be used, and examples of the extreme pressure agent include: phosphorus compounds such as phosphate esters, phosphite esters, and phosphate ester amine salts; sulfur compounds such as sulfides and disulfides; chlorine compounds such as chlorinated paraffin and chlorinated diphenyl; and metal salts of sulfur compounds such as zinc dialkyldithiophosphate and molybdenum dialkyldithiocarbamate.

Examples of the antioxidant include phenolic antioxidants, diphenylamines, phosphorus-based antioxidants, and sulfur compounds such as phenothiazine. These antioxidants may be used alone or in combination of two or more.

Among them, a phenolic antioxidant, particularly a hindered phenolic antioxidant selected from the group consisting of octadecyl-3-(3,5-di-t-butyl-4-hydroxyphenyl) propionate, 2,4-bis-(n-octylthio)-6-(4-hydroxy-3,5-di-t-butylanilino)-1,3,5-triazine, triethylene glycol-bis[3-(3-t-butyl-5-methyl-4-hydroxyphenyl) propionate], 2,2-thio-diethylene bis[3-(3,5-di-t-butyl-4-hydroxyphenyl) propionate], and octyl-3,5-di-t-butyl-4-hydroxy-hydrocinnamic acid is preferable from the viewpoint of disk adhesion. In addition, it is desirable to avoid the use of alkylated phenyl-α-naphthylamine from the viewpoint of disk adhesion.

Examples of the anti-wear agent include phosphates, phosphites, and acid phosphates.

However, from the viewpoint of disk adhesion, it is desirable to avoid the use of an amine salt of acid phosphate, which is commonly used as an anti-wear agent.

Examples of the rust inhibitor include dodecenyl succinic acid half ester.

Examples of the metal deactivator include benzotriazole-based compounds and thiadiazole-based compounds.

Examples of the viscosity index improver include polyalkyl methacrylates, polyalkyl styrenes, and polybutene.

Examples of the pour point depressant include the aforementioned viscosity index improvers such as polyalkyl methacrylates, polyalkyl styrenes, and polybutene.

Examples of the conductivity-imparting agent include nonionic surfactants, ionic liquids, and phenyl sulfonic acid.

Examples of the dispersant include polyalkenyl succinimides, polyalkenyl succinamides, polyalkenyl benzylamines, and polyalkenyl succinate esters.

Examples of the hydrolysis inhibitor include alkyl glycidyl ether type epoxy compounds, glycidyl ester type epoxy compounds, alicyclic epoxy compounds, and carbodiimides.

### [Fluid Dynamic Pressure Bearing]

Hereinafter, a preferred embodiment of the fluid dynamic pressure bearing will be described in detail with reference to the accompanying drawings.

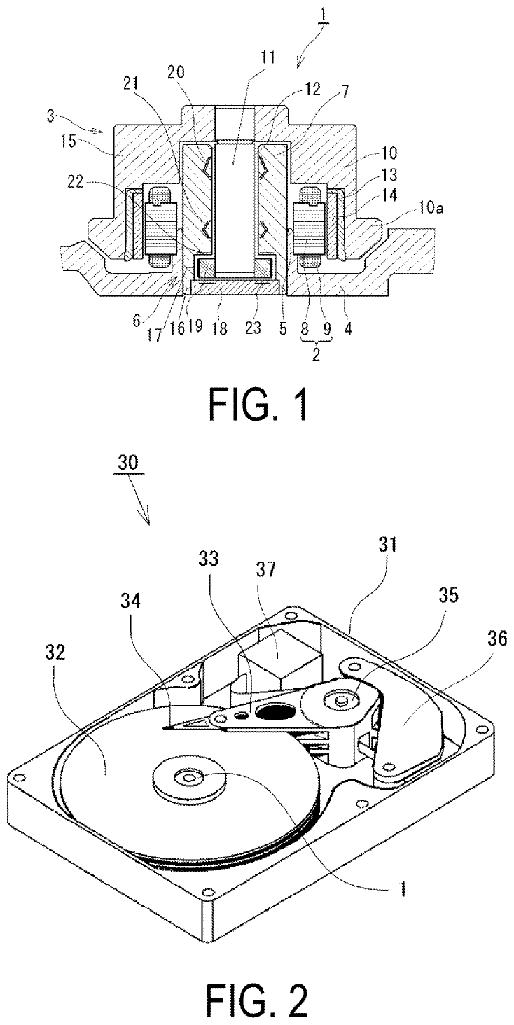

FIG. 1 is a schematic view for illustrating a fluid dynamic pressure bearing and a spindle motor including the fluid dynamic pressure bearing according to an embodiment of the present invention. Note that the embodiments described below are exemplary embodiments of the present invention, and the present invention is not limited to the embodiments.

As illustrated in FIG. 1, a spindle motor 1 is used as a motor for driving a data storage device including a magnetic disk, an optical disk, or the like used for a computer. As a whole, the spindle motor 1 includes a stator assembly 2 and a rotor assembly 3. Although the spindle motor 1 in FIG. 1 is a shaft rotating motor, the present invention is also applicable to a shaft fixed motor.

The stator assembly 2 is fixed to a cylindrical portion 5 provided to a housing 4 (base plate) constituting a casing of the data storage device in such a manner that the cylindrical portion 5 protrudes upward. A stator core 8 wound around with a stator coil 9 is fitted and attached to an outer circumferential portion of the cylindrical portion 5.

The rotor assembly 3 includes a rotor hub 10, and the rotor hub 10 is fixed to an upper end part of a shaft 11 and rotates together with the shaft 11. The shaft 11 is inserted into a sleeve 7 being a bearing member and is rotably supported by the sleeve 7. The sleeve 7 is fitted and fixed inside the cylindrical portion 5. A lower cylindrical portion 10a of the rotor hub 10 rotates inside the housing 4, but a back yoke 13 is mounted on an inner circumferential surface of the lower cylindrical portion 10a, and a rotor magnet 14 is further fitted and fixed inside the back yoke 13 and is magnetized to a plurality of poles of N and S poles.

When the stator coil 9 is energized, a magnetic field is formed by the stator core 8, and this magnetic field acts on the rotor magnet 14 disposed in the magnetic field to rotate the rotor assembly 3. On an outer circumferential surface of an intermediate cylindrical portion 15 of the rotor hub 10 of the rotor assembly 3, a recording disk, such as a magnetic disk (not illustrated), constituting a storage unit of the data storage device, is mounted, and is configured to be rotated or stopped by the operation of the spindle motor 1, so that information writing and data processing are performed by a recording head (not illustrated).

In the spindle motor 1 of such an embodiment, a fluid dynamic pressure bearing 6 is provided at a portion where the sleeve 7 rotably supports the shaft 11.

A larger-diameter first recess 16 opening downward is provided at a lower end part of the sleeve 7, and a smaller-diameter second recess 17 is further formed at a top surface of the first recess 16. A counter plate (thrust receiving plate) 18 is fitted into the large-diameter first recess 16 and fixed to the first recess 16 by, for example, welding, bonding, or the other means, so that the inside of the sleeve 7 is in an airtight state.

A thrust washer 19 is fitted, press-fitted and fixed to a lower end part of the shaft 11, and the thrust washer 19 is disposed in the second recess 17 of the sleeve 7 to rotate together with the shaft 11 while opposing the counter plate 18 and a top surface of the second recess 17.

A gap between the sleeve 7 and the shaft 11, a gap between the thrust washer 19 and the second recess 17, and a gap between the thrust washer 19/the shaft 11 and the counter plate 18 communicate with one another, and the aforementioned fluid dynamic pressure bearing oil 12 according to the present invention is sealed in the communication gaps. The fluid dynamic pressure bearing oil 12 is injected from between the sleeve 7 and the shaft 11.

A first radial dynamic pressure groove 20 and a second radial dynamic pressure groove 21 for generating dynamic pressure are formed at an inner circumferential surface of the sleeve 7 opposing the shaft 11 to be spaced apart from each other in an axial direction. Due to the rotation of the shaft 11, the radial dynamic pressure grooves 20 and 21 generate dynamic pressure causing the shaft 11 and the sleeve 7 to be in a non-contact state in a radial direction. A first thrust dynamic pressure groove 22 and a second thrust dynamic pressure groove 23 are formed at the top surface of the second recess 17 opposing an upper end surface of the thrust washer 19 and an upper end surface of the counter plate 18 opposing a lower end surface of the thrust washer 19, respectively. Due to the rotation of the shaft 11, the thrust dynamic pressure grooves 22 and 23 generate dynamic pressure for stably floating the shaft 11 in a thrust direction. Due to the operation of the dynamic pressure grooves, the shaft 11 can stably rotate at a high speed in the non-contact state with respect to the sleeve 7. As the dynamic pressure grooves, known patterns such as herringbone grooves and spiral grooves can be used.

### [Disk Drive Device]

FIG. 2 is a perspective view illustrating an overall configuration of a disk drive device 30 with the spindle motor according to the present embodiment.

As illustrated in FIG. 2, the disk drive device 30 according to the present embodiment includes a base member (base plate) 31 having a substantially rectangular box shape, the spindle motor 1 placed on the base member 31, a magnetic disk 32 configured to be rotated by the spindle motor 1, a swing arm 33 having a magnetic head 34 for writing information at a predetermined position on the magnetic disk 32 and reading information from an arbitrary position on the magnetic disk 32, a pivot assembly bearing device 35 for swingably supporting the swing arm 33, an actuator 36 for driving the swing arm 33, and a control unit 37 for controlling these components.

The disk drive device of the present invention can be a disk drive device including 9 or more 3.5-inch-diameter magnetic disks, for example. In such a device having a large number of disks, a spatial volume in the device is further reduced. The internal space of the disk drive device may be filled with a gas having a lower density than air. In such a disk drive device with its internal space filled with such a low-density gas, the air pressure inside the device may be less than one atmosphere. The disk drive device can employ a heat-assisted magnetic recording (HAMR) system as a recording system. In the disk drive device employing the heat-assisted magnetic recording (HAMR) system, the temperature of a head portion of an actuator may locally reach a high temperature of 400° C.

As described above, according to the present invention, by applying a fluid dynamic pressure bearing oil containing an aliphatic monoester compound or diester compound having a certain alkyl chain length or longer to a fluid dynamic pressure bearing and a spindle motor, the adhesion of the volatilized component to a magnetic disk or the like is reduced, and the disk read/write error of a disk drive device can be suppressed, even when the bearing oil component is volatilized during driving at a high temperature.

The present invention is not limited to the embodiment and specific examples described in the present specification, and various changes and variations can be made within the scope of the technical idea described in the claims.

### EXAMPLES

The present invention is described below in more detail with reference to examples. However, the present invention is not limited to the examples.

### [Evaluation of Various Ester Compounds for Use in Fluid Dynamic Pressure Bearing Oil]

Using the monoester compounds listed in Table 1 and the diester compounds listed in Table 2, a disk adhesion test was carried out by the following procedure. Using the diester compounds of Examples 4 to 6, a read/write error occurrence test was carried out according to the following procedure.

### Test Methods

### (1) Disk Adhesion Test

An aluminum magnetic disk plated with electroless nickel was washed with n-hexane and isopropyl alcohol each having a purity of 99% or more, each twice, and then completely dried. 5 μL of a monoester compound/diester compound (sample oil) diluted to 10 vol % with hexane was dropped onto the disk, and the disk was left to stand for 1 hour.

The state of the droplet after dropping was photographed by a camera fixed above the disk. The total areas of the droplet immediately after dropping (about 5 seconds after dropping) and after standing for 1 hour after dropping were calculated by image analysis software, and the percentage (%) of the area value after standing for 1 hour after dropping to the area value immediately after dropping [area value after 1 hour after dropping (final area)/area value immediately after dropping (initial area)] was determined as “disk adhesion” (when the area values before and after standing do not change at all, the disk adhesion is 100%).

This test was repeated a plurality of times for one sample at a temperature in a range of 20 to 30° C. and a humidity in a range of 30 to 70% RH, and an average value of readings when reproducibility (result of area values: within ±5%, N=4 or more) was obtained was adopted as the test result. Based on the results obtained, the disk adhesion was evaluated according to the following criteria.

The results obtained are listed in Tables 1 and 2.

### <Evaluation Criteria>

A: Disk adhesion was less than 50%.
N: Disk adhesion was 50% or more.

### (2) Read/Write Error Occurrence Test

A cover of a unused disk drive device was removed, and 20 mg of a base oil (sample oil) was applied to a periphery of an upper portion of a control unit (control unit 37 in FIG. 2) on a back surface (an inner surface of the housing, not illustrated in FIG. 2) of the cover. Then, the cover coated with the sample oil was mounted back on the disk drive device. The same type of disk drive device was used for all samples. Five tests (N=5) were conducted for each test condition.

A heater was placed in contact with the cover surface (an external surface of the housing, not illustrated in FIG. 2) in the vicinity of the application portion of the oil, and the temperature of the heater contacting the cover surface was maintained at 120° C. for 48 hours. After that, the disk drive device was kept at room temperature for 48 hours. In the meantime, a speed measurement software (such as CrystalDiskInfo) for the disk drive device was run to repeatedly carry out measurements, thereby continuing operation of the disk drive device. A connected computer monitored the occurrence of read/write errors in the disk drive device during the operation. The time at which the software determined that the disk drive device failed due to the occurrence of a read/write error and the monitoring was stopped was recorded as the test stop time. The test was passed if the monitoring was not stopped during the 96-hour test period. The results obtained are listed in Table 2 below.

### <Evaluation Criteria>

A: The monitoring by the software was not stopped during the 96-hour test period
N: The software monitoring stopped during the 96-hour test period

When the base oil is volatilized due to an increase in ambient temperature, part of the volatilized base oil is condensed when the temperature decreases, and the condensed base oil adheres to, for example, a disk or a head of a disk drive device, which would cause an error of the device. That is, it can be said that an error is likely to occur at the timing when the temperature is decreased, and on the other hand, if no error occurs during the time when the temperature is decreased, it can be determined that the temperature increase level before the temperature is decreased is acceptable.

In this test, it is important that the steps from the removal of the cover of the disk drive device to the remounting are carried out in a clean room in order to avoid contamination from the outside. In implementation of this test, the test was carried out without applying the sample oil, and it was confirmed that the monitoring did not stop even after 96 hours, which was the test termination time.

TABLE 1
Monoester compounds

| | | R₁ | | R₂ | |
|---|---|---|---|---|---|
| | | Total | Number of | Total | Number of |
| | | number of | side chain | number of | side chain |
| | | carbon | carbon | carbon | carbon |
| | | atoms | atoms*¹ | atoms | atoms*¹ |
| R₁—C(═O)O—R₂ | | (10 to 23) | (10 to 15) | (9 to 20) | (7 to 8) |
| Comparative Example 1 | 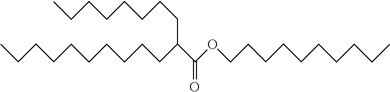 [SMILES: CCCCCCCCCCOC(=O)C(CCCCCCCC)CCCCCCCCCC] | 19 | 8 | 10 | — |
| Example 1 | 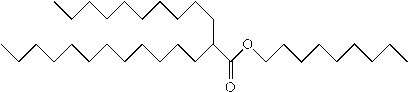 [SMILES: CCCCCCCCCCCCC(CCCCCCCCCC)C(=O)OCCCCCCCCC] | 23 | 10 | 9 | — |
| Comparative Example 2 | 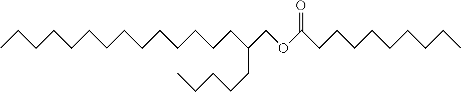 [SMILES: CCCCCCCCCCCCCCC(CCCCC)COC(=O)CCCCCCCCC] | 21 | 5 | 9 | — |
| Comparative Example 3 | 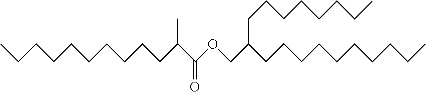 [SMILES: CCCCCCCCCCC(CCCCCCCC)COC(=O)C(C)CCCCCCCCCC] | 12 | 1 | 20 | 8 |
| Comparative Example 4 | 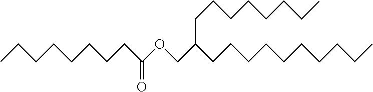 [SMILES: CCCCCCCCCCC(CCCCCCCC)COC(=O)CCCCCCCC] | 8 | — | 20 | 8 |
| Comparative Example 5 | 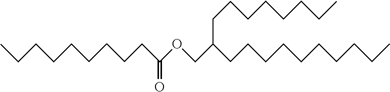 [SMILES: CCCCCCCCCCC(CCCCCCCC)COC(=O)CCCCCCCCC] | 9 | — | 20 | 8 |
| Example 2 | 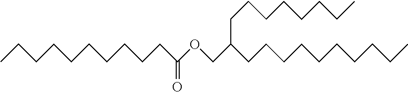 [SMILES: CCCCCCCCCCC(=O)OCC(CCCCCCCC)CCCCCCCCCC] | 10 | — | 20 | 8 |
| Comparative Example 6 | 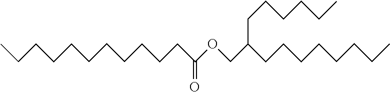 [SMILES: CCCCCCCCCCCC(=O)OCC(CCCCCC)CCCCCCCC] | 11 | — | 16 | 6 |
| Example 3 | 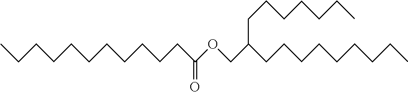 [SMILES: CCCCCCCCCCCC(=O)OCC(CCCCCCC)CCCCCCCCC] | 11 | — | 18 | 7 |
| | | | | | Kinematic |
| | | | | | viscosity |
| | | Disk | | Molecular | at 40° C. |
| R₁—C(═O)O—R₂ | | adhesion | Evaluation | weights | (mm²/s) |
| Comparative Example 1 | 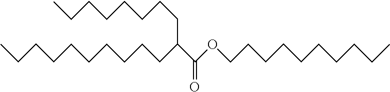 [SMILES: CCCCCCCCCCOC(=O)C(CCCCCCCC)CCCCCCCCCC] | 98% | N | 453 | 11.5 |
| Example 1 | 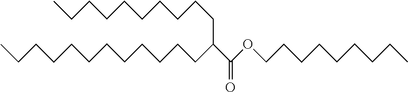 [SMILES: CCCCCCCCCCCCC(CCCCCCCCCC)C(=O)OCCCCCCCCC] | 29% | A | 495 | 14.3 |
| Comparative Example 2 | 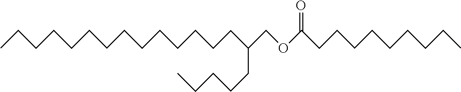 [SMILES: CCCCCCCCCCCCCCC(CCCCC)COC(=O)CCCCCCCCC] | 99% | N | 467 | 14.5 |
| Comparative Example 3 | 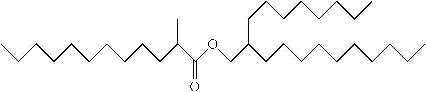 [SMILES: CCCCCCCCCCC(CCCCCCCC)COC(=O)C(C)CCCCCCCCCC] | 88% | N | 495 | 13.3 |
| Comparative Example 4 | 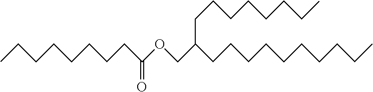 [SMILES: CCCCCCCCCCC(CCCCCCCC)COC(=O)CCCCCCCC] | 92% | N | 439 | 11.9 |
| Comparative Example 5 | 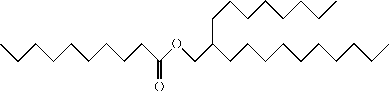 [SMILES: CCCCCCCCCCC(CCCCCCCC)COC(=O)CCCCCCCCC] | 85% | N | 453 | 13.0 |
| Example 2 | 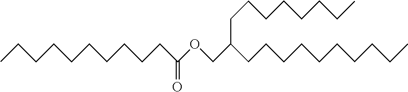 [SMILES: CCCCCCCCCCC(=O)OCC(CCCCCCCC)CCCCCCCCCC] | 35% | A | 467 | 14.0 |
| Comparative Example 6 | 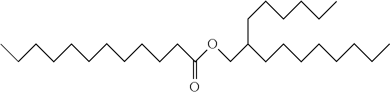 [SMILES: CCCCCCCCCCCC(=O)OCC(CCCCCC)CCCCCCCC] | 99% | N | 429 | 11.4 |
| Example 3 | 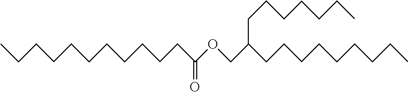 [SMILES: CCCCCCCCCCCC(=O)OCC(CCCCCCC)CCCCCCCCC] | 9% | A | 439 | 14.9 |

*¹The number of side chain carbon atoms: the number of carbon atoms in the side chain portion of a branched alkyl group

TABLE 2
Diester compounds

| | |
|---|---|
| R₃, R₅ | R₄ |

| | | Total | Number | Total | |
|---|---|---|---|---|---|
| | | number | of carbon | number | |
| | | of | atoms in | of | Number of |
| | | carbon | longest | carbon | side chain |
| | | atoms | chain*² | atoms | carbon |
| R₃-E₁-R₄-E₂-R₅ | | (8 to 10) | (9 to 11) | (4 to 6) | atoms*¹ |
| Com- parative Example 7 | 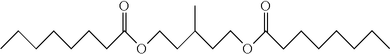 [SMILES: CCCCCCCC(=O)OCCC(C)CCOC(=O)CCCCCCC] | 7 | — | 6 | 1 |
| Example 4 | 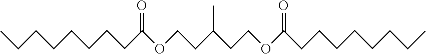 [SMILES: CCCCCCCCC(=O)OCCC(C)CCOC(=O)CCCCCCCC] | 8 | — | 6 | 1 |
| Example 5 | 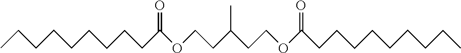 [SMILES: CCCCCCCCCC(=O)OCCC(C)CCOC(=O)CCCCCCCCC] | 9 | — | 6 | 1 |
| Example 6 | 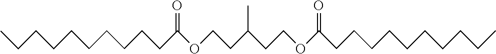 [SMILES: CCCCCCCCCCC(=O)OCCC(C)CCOC(=O)CCCCCCCCCC] | 10 | — | 6 | 1 |
| Com- parative Example 8 | 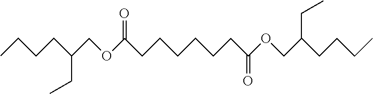 [SMILES: CCCCC(CC)COC(=O)CCCCCCC(=O)OCC(CC)CCCC] | 8 | 6 | 6 | — |
| Example 7 | 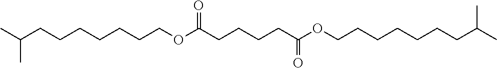 [SMILES: CC(C)CCCCCCCOC(=O)CCCCC(=O)OCCCCCCCC(C)C] | 10 | 9 | 4 | — |

| | | | | Read/ | | |
|---|---|---|---|---|---|---|
| | | | | write | | Kinematic |
| | | Disk | | error | Molec- | viscosity |
| | | adhe- | Eval- | Eval- | ular | at 40° C. |
| R₃-E₁-R₄-E₂-R₅ | | sion | uation | uation | weights | (mm²/s) |
| Com- parative Example 7 | 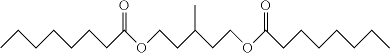 [SMILES: CCCCCCCC(=O)OCCC(C)CCOC(=O)CCCCCCC] | 92% | N | — | 371 | 7.4 |
| Example 4 | 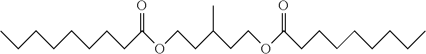 [SMILES: CCCCCCCCC(=O)OCCC(C)CCOC(=O)CCCCCCCC] | 4% | A | A | 399 | 8.9 |
| Example 5 | 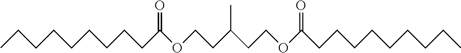 [SMILES: CCCCCCCCCC(=O)OCCC(C)CCOC(=O)CCCCCCCCC] | 11% | A | A | 427 | 10.6 |
| Example 6 | 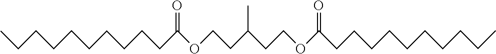 [SMILES: CCCCCCCCCCC(=O)OCCC(C)CCOC(=O)CCCCCCCCCC] | 9% | A | A | 455 | 12.7 |
| Com- parative Example 8 | 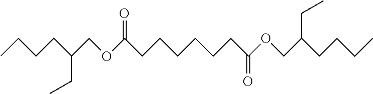 [SMILES: CCCCC(CC)COC(=O)CCCCCCC(=O)OCC(CC)CCCC] | 95% | N | — | 427 | 11.9 |
| Example 7 | 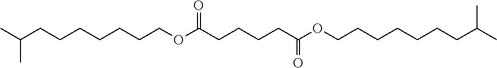 [SMILES: CC(C)CCCCCCCOC(=O)CCCCC(=O)OCCCCCCCC(C)C] | 11% | A | — | 427 | 14.8 |

*¹The number of side chain carbon atoms: the number of carbon atoms in the side chain portion of the branched alkyl group
*²The number of carbon atoms in the longest chain: the number of carbon atoms in the longest carbon chain counted from the carbon atom bonded to E₁ or E₂.

As listed in Tables 1 and 2, it was confirmed that the monoester compounds of Examples 1 to 3 and the diester compounds of Examples 4 to 7 are compounds that are less adhesive to the disk than the compounds of Comparative Examples.

In addition, as listed in Table 2, from the results of the read/write error occurrence test using the diester compounds of Examples 4 to 6, it was confirmed that the compounds that are less adhesive to the disk hardly causes a read/write error in the actual machine. From this, it was confirmed that there is a correlation between the disk adhesion and the occurrence of read/write errors.

The best embodiments have been described in detail above, but the present invention is not limited to the embodiments described above, and variations, modifications, and the like within a range in which the object of the present invention can be achieved are included in the present invention.

### REFERENCE SIGNS LIST

1: Spindle Motor; 2: Stator Assembly; 3: Rotor Assembly; 4: Housing; 5: Cylindrical Portion; 6: Fluid Dynamic Pressure Bearing; 7: Sleeve; 8: Stator Core; 9: Stator Coil; 10: Rotor Hub; 10a: Lower Cylindrical Portion; 11: Shaft; 12: Fluid Dynamic Pressure Bearing Oil; 13: Back Yoke; 14: Rotor Magnet; 15: Intermediate Cylindrical Portion; 16: First Recess; 17: Second Recess; 18: Counter Plate; 19: Thrust Washer; 20: First Radial Dynamic Pressure Groove; 21: Second Radial Dynamic Pressure Groove; 22: First Thrust Dynamic Pressure Groove; 23: Second Thrust Dynamic Pressure Groove; 30: Disk Drive Device; 31: Base Member (Base Plate); 32: Magnetic Disk; 33: Swing Arm; 34: Magnetic Head; 35: Pivot Assembly Bearing Device; 36: Actuator; 37: Control Unit.

The invention claimed is:

1. A fluid dynamic pressure bearing oil for use in a disk drive device, the fluid dynamic pressure bearing oil comprising:
at least one compound selected from the group consisting of a monoester compound represented by the following Formula (1) and a diester compound represented by the following Formula (2):
R₁—C(═O)O—R₂ (1)
where
R₁ is a linear or branched alkyl group having 10 or more carbon atoms in total, and when R₁ is a branched alkyl group, a number of carbon atoms in a side chain is 10 or more;
R₂ is a linear or branched alkyl group having 9 or more carbon atoms in total, and when R₂ is a branched alkyl group, a number of carbon atoms in a side chain is 7 or more,
R₃-E₁-R₄-E₂-R₅ (2)
where
R₃ and R₅ are each independently a linear or branched alkyl group having 8 or more carbon atoms in total, and when R₃ and R₅ are branched alkyl groups, a number of carbon atoms in the longest carbon chain counted from a carbon atom bonded to E₁ or E₂ is 9 or more,
R₄ is a linear or branched alkylene group having 4 or more carbon atoms in total, and
E₁ and E₂ are each independently —C(—O)O— or —OC(═O)—.

2. The fluid dynamic pressure bearing oil according to claim 1, wherein in Formula (1),
R₁ is a linear or branched alkyl group having 23 or less carbon atoms in total, and when R₁ is a branched alkyl group, the number of carbon atoms in the side chain is 15 or less; and
R₂ is a linear or branched alkyl group having 20 or less carbon atoms in total, and when R₂ is a branched alkyl group, the number of carbon atoms in the side chain is 8 or less.

3. The fluid dynamic pressure bearing oil according to claim 1, wherein in Formula (1),
one of R₁ and R₂ is a linear alkyl group, and the other one is a branched alkyl group.

4. The fluid dynamic pressure bearing oil according to claim 1, wherein in Formula (2),
R₃ and R₅ are each independently a linear or branched alkyl group having 10 or less carbon atoms in total, and
R₄ is a linear or branched alkylene group having 6 or less carbon atoms in total.

5. The fluid dynamic pressure bearing oil according to claim 4, wherein in Formula (2),
R₃ and R₅ are both linear alkyl groups and R₄ is a branched alkyl group, or
R₃ and R₅ are both branched alkyl groups and R₄ is a linear alkyl group.

6. The fluid dynamic pressure bearing oil according to claim 5, wherein in Formula (2),
R₃ and R₅ both represent an identical group, and
E₁ represents —C(═O)O— and E₂ represents —OC(═O)—, or
E₁ represents —OC(═O)— and E₂ represents —C(═O)O—.

7. The fluid dynamic pressure bearing oil according to claim 6, wherein in Formula (2),
R₃ and R₅ represent an identical linear alkyl group, R₄ represents an identical branched alkyl group, E₁ represents —═O)O—, and E₂ represents —OC(═O)—, or
R₃ and R₅ represent an identical branched alkyl group, R₄ represents an identical linear alkyl group, E₁ represents —OC(═O)—, and E₂ represents —═O)O—.

8. The fluid dynamic pressure bearing oil according to claim 1, wherein the fluid dynamic pressure bearing oil does not contain alkylated phenyl-α-naphthylamine as an antioxidant.

9. The fluid dynamic pressure bearing oil according to claim 1, further comprising a phenolic antioxidant.

10. The fluid dynamic pressure bearing oil according to claim 9, wherein the phenolic antioxidant is a hindered phenolic antioxidant.

11. The fluid dynamic pressure bearing oil according to claim 10, wherein the hindered phenolic antioxidant is at least one selected from the group consisting of octadecyl-3-(3,5-di-t-butyl-4-hydroxyphenyl)propionate, 2,4-bis-(n-octylthio)-6-(4-hydroxy-3,5-di-t-butylanilino)-1,3,5-triazine, triethylene glycol-bis[3-(3-t-butyl-5-methyl-4-hydroxyphenyl)propionate], 2,2-thio-diethylene bis[3-(3,5-di-t-butyl-4-hydroxyphenyl)propionate], and octyl-3,5-di-t-butyl-4-hydroxy-hydrocinnamic acid.

12. The fluid dynamic pressure bearing oil according to claim 1, wherein the fluid dynamic pressure bearing oil does not contain an amine salt of acid phosphate as an anti-wear agent.

13. A fluid dynamic pressure bearing filled with the fluid dynamic pressure bearing oil according to claim 1.

14. A spindle motor comprising the fluid dynamic pressure bearing according to claim 13.

15. A disk drive device equipped with the spindle motor according to claim 14.

16. The disk drive device according to claim 15, further comprising 9 or more 3.5-inch-diameter disks.

17. The disk drive device according to claim 15, having an internal space filled with a gas having a lower density than air.

18. The disk drive device according to claim 1, wherein the disk drive device employs a thermally assisted magnetic recording system.
